(19) United States
(12) Patent Application Publication
(10) Pub. No.: US 2026/0077711 A1
(43) Pub. Date: Mar. 19, 2026

(54) FLOODLIGHT LEATHER MOOD LAMP FOR VEHICLE AND MANUFACTURING METHOD THEREOF

(71) Applicants: HYUNDAI MOTOR COMPANY, Seoul (KR); Kia Corporation, Seoul (KR)

(72) Inventor: Lin Peng SONG, Shandong (CN)

(73) Assignees: HYUNDAI MOTOR COMPANY, Seoul (KR); Kia Corporation, Seoul (KR)

(21) Appl. No.: 19/324,764

(22) Filed: Sep. 10, 2025

(30) Foreign Application Priority Data
Sep. 18, 2024 (CN) 202411302905.4

(51) Int. Cl. B60Q 3/74; B60Q 3/60; B60Q 3/82; F21V 3/06; F21V 23/04

(52) U.S. Cl. CPC B60Q 3/74; B60Q 3/60; B60Q 3/82; F21V 3/0625; F21V 23/0471

(57) ABSTRACT

A floodlight leather mood lamp for a vehicle and a manufacturing method thereof are disclosed. The mood lamp for a vehicle includes a bottom assembly including a housing, a light source, and a diffusion membrane; and a top assembly including a core, a mesh, and a floodlight leather, in which the light source is located on one side of the housing close to the diffusion membrane, and an ink layer is applied to the core.

### CROSS-REFERENCE TO RELATED APPLICATION

This application claims priority to and the benefit of Chinese Patent Application No. 202411302905.4 filed with the Chinese Intellectual Property Office on Sep. 18, 2024, the entire contents of which are incorporated herein by reference.

### BACKGROUND OF THE DISCLOSURE

### (a) Field of the Disclosure

The present disclosure relates to a mood lamp for a vehicle and a manufacturing method thereof, and more particularly, to a soft leather mood lamp capable of implementing a flow lighting effect and a manufacturing method thereof using an in-mold embossing molding process (IMG).

### (b) Description of the Related Art

Vehicle users want to improve the quality of the interior of their vehicles. Accordingly, a soft leather mood lamp with a styling pattern lighting effect has been developed recently.

Chinese Utility Model CN217540488U relates to a soft leather mood lamp, but the mood lamp may only implement a single lighting effect, and a polyurethane (PU) leather on a surface should be manually attached and assembled to the surface, and may not be assembled by an in-mold embossing molding process. Therefore, a lighting effect, the production efficiency, and a leather-patterned appearance are all not ideal.

Chinese utility model CN219775519U relates to a vehicle mood lamp with a three-dimensional flowing effect. Due to a complex trapezoidal plate structure, a shape of the mood lamp is difficult to be appropriately applied to complex-shaped interior parts of a vehicle,

Therefore, a soft leather mood lamp, which may have improved lighting effect, production efficiency, and leather-patterned appearance and may be appropriately applied to complex shapes, is still needed.

Matters disclosed in this Background Art is only for enhancement of understanding of the background of the disclosure, and therefore, may include matters that are not included in the prior art that is already known in this country to a person of ordinary skill in the art.

### SUMMARY

The present disclosure attempts to provide a soft leather mood lamp capable of having an improved lighting effect, production efficiency, and leather-patterned appearance and being appropriately applied to complex shapes.

An aspect of the present disclosure provides a mood lamp for a vehicle. The mood lamp for a vehicle includes a bottom assembly including a housing, a light source, and a diffusion membrane, and a top assembly including a core, a mesh, and a floodlight leather, in which the light source may be located on one side of the housing close to the diffusion membrane, and an ink layer may be applied to the core.

The core may be located on one side of the diffusion membrane far from the housing, the mesh may be located on one side of the core far from the diffusion membrane, and the floodlight leather may be located on one side of the mesh far from the core.

In one example, the ink layer may be applied to one side of the core far from the diffusion membrane and may define a pattern including a floodlight portion and a non-floodlight portion.

In another example, the ink layer may be applied to one side of the core close to the diffusion membrane and may define a pattern including a floodlight portion and a non-floodlight portion.

The floodlight leather may sequentially include a surface treatment layer, a leather layer, an adhesive layer, and a fabric layer from one side far from the mesh to one side close to the mesh.

A material of the housing may be polycarbonate+acrylonitrile-butadiene-styrene, and a thickness of the housing may be about 2.5 to about 3.0 mm.

The light source may include two or more light-emitting diodes.

A material of the diffusion membrane may be polycarbonate, and a thickness of the diffusion membrane may be about 0.1 to about 0.2 mm.

A material of the core may be polycarbonate, and a thickness of the core may be about 2.2 to about 2.7 mm.

A material of the ink layer may be printing ink, and a thickness of the ink layer may be about 0.065 to about 0.075 mm.

A material of the mesh may be terylene and have a three-dimensional structure, and a thickness of the mesh may be about 3 to about 10 mm.

A material of the surface treatment layer may be a heat-resistant resin, and a thickness of the surface treatment layer may be about 0.05 to about 0.15 mm.

A material of the leather layer may be thermoplastic polyolefin, and a thickness of the leather layer may be about 0.2 to about 0.7 mm.

A material of the adhesive layer may be high temperature melting polyurethane, and a thickness of the adhesive layer may be about 0.05 to about 0.15 mm.

A material of the fabric layer may be polyethylene glycol terephthalate, and a thickness of the fabric layer may be about 0.5 to about 1 mm.

The light source may be assembled to the housing through a screw, the diffusion membrane may be assembled to the housing through a buckle, the core, the mesh, and the floodlight leather may be assembled through an in-mold embossing molding process, and the bottom assembly and the top assembly may be assembled to each other through the screw.

The mood lamp for a vehicle may further include a touch switch coupled to the mood lamp for the vehicle.

Another aspect of the present disclosure provides a manufacturing method of the mood lamp for a vehicle described above. The manufacturing method includes: assembling a light source and a diffusion membrane to a housing to manufacture a bottom assembly; assembling a floodlight leather, a mesh, and a core through an in-mold embossing molding process to manufacture a top assembly; and assembling the bottom assembly and the top assembly.

The in-mold embossing molding process may include: vacuum molding the floodlight leather by heating the floodlight leather; obtaining a core through injection molding; spraying an ink layer to the core and bonding the mesh; and press molding the floodlight leather, the mesh, and the core.

The floodlight leather may be heated to a temperature of about 170 to about 180° C.

According to the present disclosure, since not only the static lighting having the ink layer pattern shape but also the dynamic flow lighting may be displayed, it is possible to improve the lighting effect.

In addition, since the leather mood lamp may be manufactured using the in-mold embossing molding process, it is possible to improve the production efficiency and the leather pattern appearance.

Furthermore, since the structure is simple, it may be appropriately applied to interior members of a vehicle having a complex shape.

Other effects that may be obtained or are predicted by an exemplary embodiment of the present disclosure will be explicitly or implicitly described in a detailed description of the present disclosure. That is, various effects that are predicted according to an exemplary embodiment of the present disclosure will be described in the following detailed description.

### BRIEF DESCRIPTION OF THE DRAWINGS

The above and other features of the present disclosure will be described in detail with reference to some exemplary embodiments illustrated in the drawings. The drawings are only for the purpose of the following description and do not limit the present disclosure.

FIG. 1 is a schematic exploded view of a soft leather mood lamp according to the related art.

FIG. 2 is a schematic exploded view of a soft leather mood lamp according to an exemplary embodiment of the present disclosure.

FIG. 3 is a diagram illustrating a schematic assembly diagram of the soft leather mood lamp according to an exemplary embodiment of the present disclosure.

FIG. 4 is a schematic cross-sectional view of the soft leather mood lamp according to an exemplary embodiment of the present disclosure along the line A-A of FIG. 3.

FIG. 5 is a schematic cross-sectional view of a core portion of the soft leather mood lamp according to an exemplary embodiment of the present disclosure along the line A-A of FIG. 3.

FIG. 6 is a schematic cross-sectional view of a floodlight leather portion of the soft leather mood lamp according to an exemplary embodiment of the present disclosure along the line A-A of FIG. 3.

FIG. 7 is a diagram illustrating an operating principle of the soft leather mood lamp according to an exemplary embodiment of the present disclosure in a turned-off state through the schematic cross-sectional view along the line A-A of FIG. 3.

FIG. 8 is a diagram illustrating an operating principle of the soft leather mood lamp according to an exemplary embodiment of the present disclosure in a turned-on state through the schematic cross-sectional view along the line A-A of FIG. 3.

FIG. 9 is a schematic cross-sectional view of the soft leather mood lamp according to an exemplary embodiment of the present disclosure along the line B-B of FIG. 3.

FIG. 10 is a diagram illustrating a flow lighting effect of the soft leather mood lamp according to an exemplary embodiment of the present disclosure.

FIG. 11 is a diagram illustrating an example in which the soft leather mood lamp according to an exemplary embodiment of the present disclosure and a touch switch are coupled with each other.

FIG. 12 is a diagram illustrating a manufacturing method of a soft leather mood lamp according to another exemplary embodiment of the present disclosure using an in-mold embossing molding process (IMG).

Hereinafter, the exemplary embodiments of the present disclosure will be described in more detail with reference to the drawings. For clarity of description, the same parts are indicated by the same reference numerals in different drawings. It should be noted that the drawings are exemplary only and are not necessarily drawn to scale.

It should be understood that the drawings are somewhat simplified representations of various features explaining the basic principles of the present disclosure and are not drawn to scale. Specific design features (including, for example, specific sizes, directions, positions, and shapes) of the present disclosure disclosed in the present disclosure are partly determined according to specific applications and environments in which they are used.

In these drawings, the same reference numbers throughout the drawings indicate identical or equivalent parts of the present disclosure.

### DETAILED DESCRIPTION OF THE EMBODIMENTS

Hereinafter, the present disclosure will be described in detail with reference to exemplary embodiments thereof, which are illustrated in the drawings and described below. Although the present disclosure is described with reference to exemplary embodiments thereof, it should be understood that the present specification is not intended to limit the present disclosure to these exemplary embodiments. On the contrary, the present disclosure may encompass not only the exemplary embodiments thereof, but also various alternative forms, modifications, equivalent forms, and other exemplary embodiments that may be included within the spirit and scope of the present disclosure as defined by the claims.

The present disclosure will be more clearly understood through the following exemplary embodiments presented. However, the present disclosure is not limited to the exemplary embodiments disclosed in the text, and may be modified in different forms. These exemplary embodiments are provided in order to thoroughly understand the present disclosure and sufficiently convey the spirit of the present disclosure to those skilled in the art.

In all the drawings, the same reference numerals represent the same or similar components. For the clarity of the present disclosure, the sizes of the structures are drawn larger than their actual sizes. It should be understood that, although the text may use terms such as “first,” “second,” etc., to describe each component, these components are not limited by these terms. These terms are only intended to distinguish one component from another. For example, without departing from the scope of the present disclosure, the “first” component discussed below may be referred to as the “second” component. Similarly, a “second” component may also be referred to as a “first” component. Unless the context clearly indicates otherwise, the singular form also includes the plural form.

In addition, the terms “comprising,” “having,” etc. used herein specify the presence of a feature, value, step, operation, element, component, or combination thereof, but do not preclude the presence or addition of one or more other features, values, steps, operations, elements, components, or combinations thereof. It will also be understood that when a component (e.g., a layer, film, region, or sheet) is “on” another component, it means that there may be components directly on top of or intervening between the other component. Similarly, when a component (e.g., a layer, film, region, or sheet) is “under” another component, it means that there may be components directly on top of or intervening between the other component.

Unless otherwise stated, all numbers, figures, and/or expressions expressing quantities of ingredients, reaction conditions, copolymer compositions, and mixtures used herein are to be considered approximations that involve various uncertainties (in particular, which may affect the inherent measurement values in obtaining such values), and therefore should be understood to be modified in all instances by the term “about.”

In addition, where a numerical range is disclosed herein, unless otherwise stated, that range is continuous and includes all values from the minimum value to the maximum value in that range. In addition, where such a range relates to integer values, unless otherwise stated, all integers from the minimum value to the maximum value should be included.

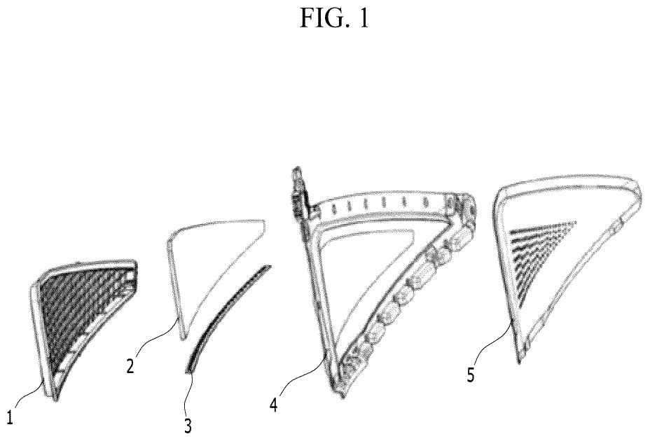

FIG. 1 is a schematic exploded view of a soft leather mood lamp according to the related art. The soft leather mood lamp includes a cover 1, a light guide 2, a printed circuit board assembly (PCBA) 3, a two-color core 4, and a polyurethane (PU) leather 5. A light emitting diode (LED) of the PCBA 3 is installed on an end surface of the light guide 2, and the PU leather 5 has a skin pattern layer formed with water-based ink. In the case of such a soft leather mood lamp, the PU leather 5 may be covered only by simple manual work and may not be covered through an in-mold embossing molding process (In-Mold Grain (IMG)). The reason is that, firstly, based on that the PU leather 5 is covered through the in-mold embossing molding process 5, the leather may be damaged, and the leather pattern may be deformed due to tension, and secondly, since the PU leather 5 should be heated to a high temperature (about 170 to about 180° C.) during the IMG molding, but a heat-resistant temperature of the water-based ink of the skin pattern layer is 120° C., the ink may melt and be destroyed. In addition, since the LED is installed on the end surface of the light guide 2, only a single lighting effect of different colors may be implemented, and a flow lighting effect of different colors may not be implemented.

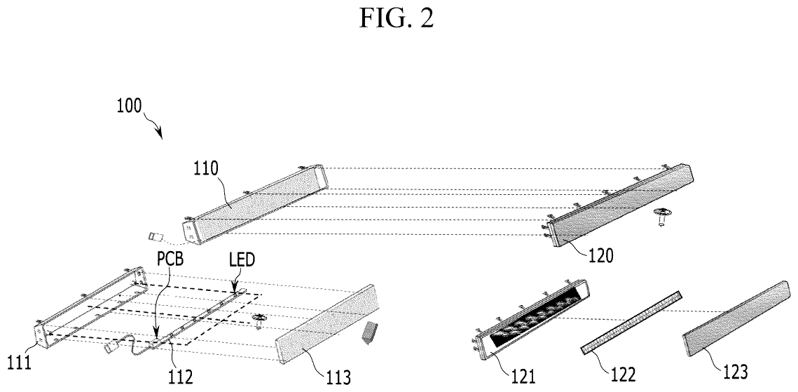

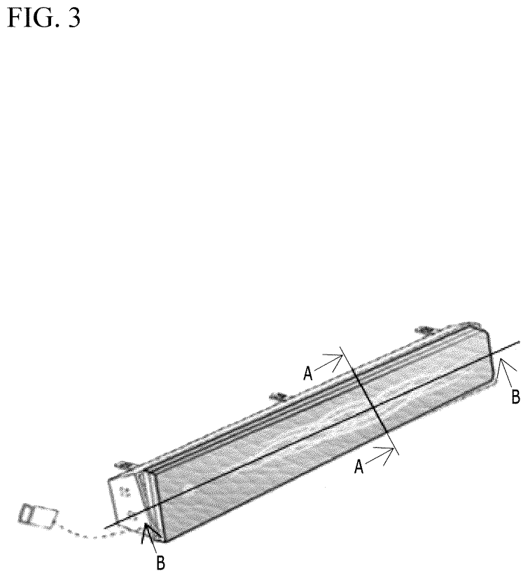

FIG. 2 is a schematic exploded view of a soft leather mood lamp according to an exemplary embodiment of the present disclosure, and FIG. 3 is a diagram illustrating a schematic assembly diagram of the soft leather mood lamp according to an exemplary embodiment of the present disclosure. As illustrated in FIGS. 2 and 3, the soft leather mood lamp 100 according to an exemplary embodiment of the present disclosure includes a bottom assembly 110 and a top assembly 120. The bottom assembly 110 includes a housing 111, a light source 112, and a diffusion membrane 113. The top assembly 120 includes a core 121, a mesh 122, and a floodlight leather 123. The light source 112 is located on one side of the housing 111 close to the diffusion membrane 113, so that, unlike the related art, the light source 112 is located on a back surface, not the end surface, of the diffusion membrane 113. An ink layer 121-1 is applied to the core 121. The light source 112 may be assembled to the housing 111 through a screw, and the diffusion membrane 113 may be assembled to the housing 111 through a buckle. The core 121, the mesh 122, and the floodlight leather 123 are assembled through the in-mold embossing molding process, and the bottom assembly 110 and the top assembly 120 may be assembled to each other through the screw.

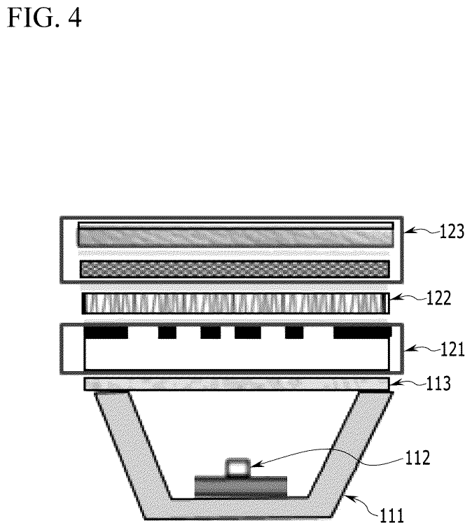

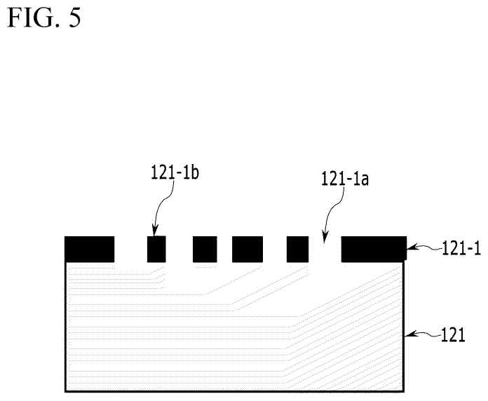

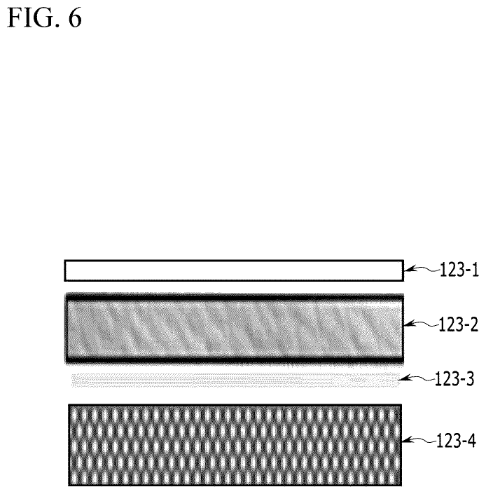

FIG. 4 is a schematic cross-sectional view of the soft leather mood lamp according to an exemplary embodiment of the present disclosure along the line A-A of FIG. 3, FIG. 5 is a schematic cross-sectional view of a core portion of the soft leather mood lamp according to an exemplary embodiment of the present disclosure along the line A-A of FIG. 3, and FIG. 6 is a schematic cross-sectional view of a floodlight leather portion of the soft leather mood lamp according to an exemplary embodiment of the present disclosure along the line A-A of FIG. 3. As illustrated in FIGS. 4, 5 and 6, the core 121 is located on one side of the diffusion membrane 113 far from the housing 111, the mesh 122 is located on one side of the core 121 far from the diffusion membrane 113, and the floodlight leather 123 is located on one side of the mesh 122 far from the core 121. The ink layer 121-1 is applied to one side of the core 121 far from the diffusion membrane 113 and defines a pattern including a floodlight portion 121-1a and a non-floodlight portion 121-1b. Alternatively, the ink layer 121-1 may also be applied to one side of the core 121 close to the diffusion membrane 113 and may define the pattern including the floodlight portion 121-1a and the non-floodlight portion 121-1b (not illustrated). The floodlight leather 123 sequentially includes a surface treatment layer 123-1, a leather layer 123-2, an adhesive layer 123-3, and a fabric layer 123-4 from one side far from the mesh 122 to one side close to the mesh 122.

In the soft leather mood lamp 100 according to the exemplary embodiment of the present disclosure, the housing 111 is for assembling and protecting the mood lamp, and may be manufactured from a polycarbonate+acrylonitrile-butadiene-styrene material. In one example, the thickness of the housing 111 may be about 2.5 to about 3.0 mm. In another example, the thickness of the housing 111 may be about 2.6 to about 2.9 mm. In still another example, the thickness of the housing 111 may be about 2.7 to about 2.8 mm.

In the soft leather mood lamp 100 according to the exemplary embodiment of the present disclosure, the light source 112 is for providing lighting based on that the mood lamp is turned on. The light source 112 may include two or more light-emitting diodes (LEDs) and a printed circuit board (PCB). Depending on the expected flow lighting effect, two or more light-emitting diodes may be arranged in an appropriate manner and may emit light simultaneously or sequentially.

In the soft leather mood lamp 100 according to the exemplary embodiment of the present disclosure, the diffusion membrane 113 converts point light from the light source 112 into uniform surface light, and the material may be polycarbonate. In one example, the thickness of the diffusion membrane 113 may be about 0.1 to about 0.2 mm. In another example, the thickness of the diffusion membrane 113 may be about 0.11 to about 0.19 mm. In still another example, the thickness of the diffusion membrane 113 may be about 0.12 to about 0.18 mm, about 0.13 to about 0.17 mm, or about 0.14 to about 0.16 mm.

In the soft leather mood lamp 100 according to an exemplary embodiment of the present disclosure, the core 121 is used as a support structure for the mood lamp and as a carrier for the ink layer 121-1, and the material may be polycarbonate. In one example, the thickness of the core 121 may be about 2.2 to about 2.7 mm. In another example, the thickness of the core 121 may be about 2.3 to about 2.6 mm. In still another example, the thickness of the core 121 may be about 2.4 to about 2.5 mm, or about 2.5 mm. The ink layer 121-1 is applied to the one side of the core 121 that is far from the diffusion membrane 113 or close to the diffusion membrane 113 and defines the pattern including the floodlight portion 121-1a and the non-floodlight portion 121-1b. Based on that the surface light from the diffusion membrane 113 is irradiated to the core 121, some of the light pass through the floodlight portion 121-1a and may penetrate the core 121, and other light is blocked by the non-floodlight portion 121-1b and may not penetrate the core 121. Depending on the expected flow lighting effect, the pattern of the ink layer 121-1 may include a suitable pattern shape such as a wave shape, a lightning shape, a keyboard shape, etc.

In the soft leather mood lamp 100 according to the exemplary embodiment of the present disclosure, the mesh 122 provides a soft touch to the mood lamp, and the material may be terylene and may have a three-dimensional structure. In one example, the thickness of the mesh 122 may be about 3 to about 10 mm. In another example, the thickness of the mesh 122 may be about 4 to about 9 mm. In still another example, the thickness of the mesh 122 may be about 5 to about 8 mm or about 6 to about 7 mm. The mesh 122 may be transparent and configured not to block the light emitted from the floodlight portion 121-1a of the ink layer 121-1.

In the soft leather mood lamp 100 according to the exemplary embodiment of the present disclosure, the floodlight leather 123 provides the mood lamp with a luxurious touch and appearance like leather. The surface treatment layer 123-1 of the floodlight leather 123 protects the leather layer 123-2 and improves durability of use, and the material may be a heat-resistant resin. In one example, the thickness of the surface treatment layer 123-1 may be about 0.05 to about 0.15 mm. In another example, the thickness of the surface treatment layer 123-1 may be about 0.06 to about 0.14 mm. In still another example, the thickness of the surface treatment layer 123-1 may be about 0.07 to about 0.13 mm, about 0.08 to about 0.12 mm, about 0.09 to about 0.11 mm, or about 0.1 mm. The material of the leather layer 123-2 of the floodlight leather 123 may be thermoplastic polyolefin. In one example, the thickness of the leather layer 123-2 may be about 0.2 to about 0.7 mm. In another example, the thickness of the leather layer 123-2 may be about 0.3 to about 0.6 mm. In still another example, the thickness of the leather layer 123-2 may be about 0.4 to about 0.5 mm, or about 0.5 mm. The material of the adhesive layer 123-3 of the floodlight leather 123 may be high temperature melting polyurethane. In one example, the thickness of the adhesive layer 123-3 may be about 0.05 to about 0.15 mm. In another example, the thickness of the adhesive layer 123-3 may be about 0.06 to about 0.14 mm. In still another example, the thickness of the adhesive layer 123-3 may be about 0.07 to about 0.13 mm, about 0.08 to about 0.12, about 0.09 to about 0.11 mm, or about 0.1 mm. The material of the fabric layer 123-4 of the floodlight leather 123 may be polyethylene glycol terephthalate. In one example, the thickness of the fabric layer 123-4 may be about 0.5 to about 1 mm. In another example, the thickness of the fabric layer 123-4 may be about 0.6 to about 0.9 mm. In still another example, the thickness of the fabric layer 123-4 may be about 0.7 to about 0.8 mm. According to an exemplary embodiment of the present disclosure, the light transmittance thereof may be improved by including a low pigment content of about 15 wt % to about 40 wt % in the leather layer 123-2.

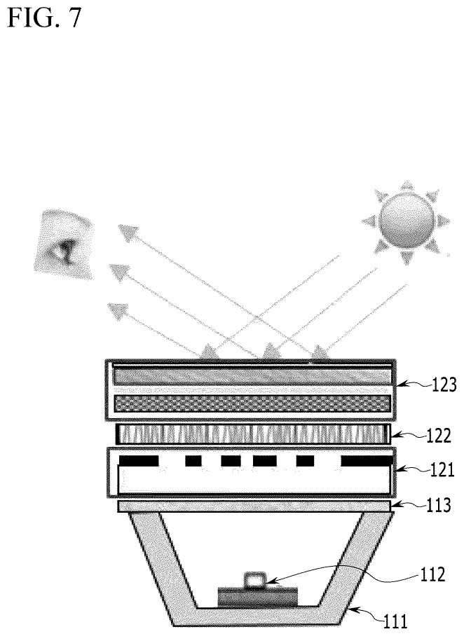

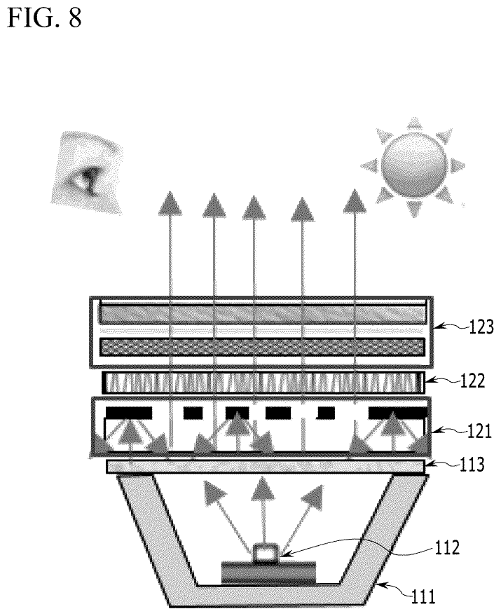

FIGS. 7 and 8 illustrate the operating principle of the soft leather mood lamp 100 according to an exemplary embodiment of the present disclosure in the turned-off and turned-on states. As illustrated in FIG. 7, while the leather mood lamp 100 is turned-off, natural light from the outside is irradiated onto the outer surface of the floodlight leather 123 and then reflected by a human eye. In this case, the leather mood lamp 100 exhibits a leather-like appearance, and an observer may not see the pattern of the ink layer 121-1. As illustrated in FIG. 8, while the leather mood lamp 100 is turned on, the point light from the light source 112 is irradiated to the diffusion membrane 113 and converted into the surface light by the diffusion membrane 113. Some of the surface light pass through the floodlight portion 121-1a and may penetrate the core 121, and other light is blocked by the non-floodlight portion 121-1b and may not penetrate the core 121. The light that has penetrated the core 121 sequentially penetrates the mesh 122 and the floodlight leather 123 and reaches the human eye. In this case, the observer may see the pattern of the ink layer 121-1.

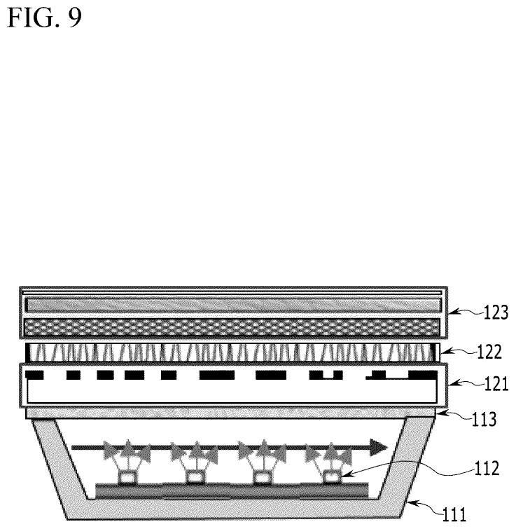

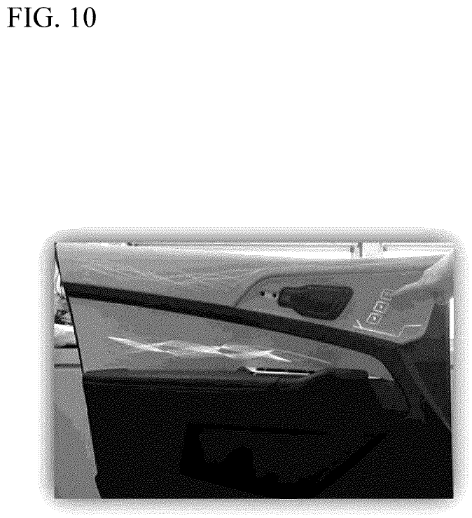

FIG. 9 is a schematic cross-sectional view of the soft leather mood lamp according to an exemplary embodiment of the present disclosure along the line B-B of FIG. 3. While the leather mood lamp 100 is turned on, two or more LEDs may emit light simultaneously or sequentially. Based on that the LEDs emit light simultaneously, a static lighting effect having the pattern shape of the ink layer appears, and based on that the LEDs emit light sequentially in a predetermined order, the leather mood lamp 100 may exhibit the desired dynamic flow lighting effect. FIG. 10 is a diagram illustrating a flow lighting effect of the soft leather mood lamp according to an exemplary embodiment of the present disclosure.

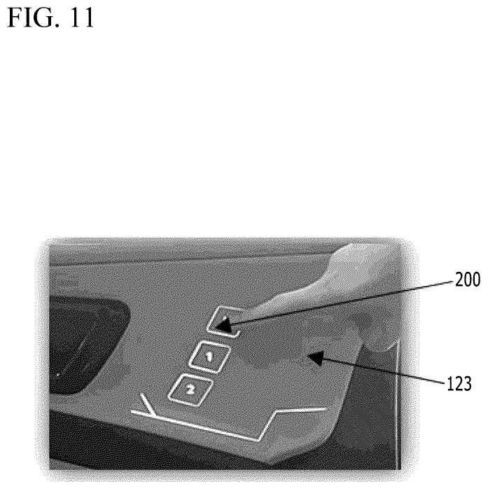

FIG. 11 is a diagram illustrating an example in which the soft leather mood lamp according to an exemplary embodiment of the present disclosure and a touch switch are coupled with each other. In this example, the soft leather mood lamp 100 according to an exemplary embodiment of the present disclosure is combined with the touch switch 200, so that the leather mood lamp 100 may exhibit the static lighting effect or the dynamic flow lighting effect in response to pressing the switch 200. This example implements a touch switch function while providing a soft touch and a luxurious appearance.

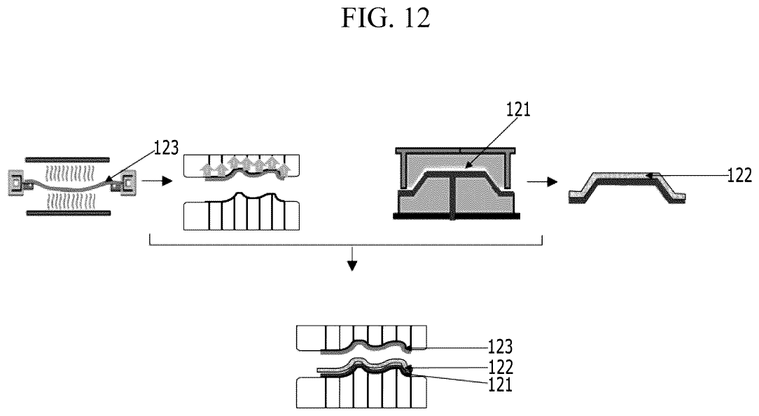

FIG. 12 is a diagram illustrating a manufacturing method of a soft leather mood lamp according to another exemplary embodiment of the present disclosure using an in-mold embossing molding process (IMG). According to the method, the floodlight leather 123 is heated to a temperature of about 170 to about 180° C., the floodlight leather 123 is formed through vacuum molding to form the leather pattern on its surface; the core 121 having the desired shape is obtained through injection molding; the ink layer having the specific pattern is sprayed to the core 121 and the mesh 122 is bonded; the vacuum-molded transparent leather 123 and the core 121 to which the ink layer is sprayed and the mesh 122 is bonded are press-molded to form the top assembly 120. In addition, the light source 112 and the diffusion membrane 113 are assembled to the housing 111 through the screw and the buckle, respectively, to form the bottom assembly 120. Finally, the bottom assembly 110 and the top assembly 120 are assembled through the screw to manufacture the soft leather mood lamp 100 according to an exemplary embodiment of the present disclosure. Since the floodlight leather 123 is manufactured using a thermoplastic polyolefin material and the ink layer is formed on the core 121, the floodlight leather 123 is not destroyed and the ink layer is not destroyed even based on that the in-mold embossing molding process (IMG) is used, thereby improving the production efficiency and implementing the appearance of the leather pattern.

The soft leather mood lamp according to an exemplary embodiment of the present disclosure may exhibit not only the static lighting having the ink layer pattern shape but also the dynamic flow lighting, thereby providing the improved lighting effect. Since the soft leather mood lamp according to an exemplary embodiment of the present disclosure is allowed to be manufactured using the in-mold embossing molding process, it may have the improved production efficiency and the leather pattern appearance. The soft leather mood lamp according to an exemplary embodiment of the present disclosure has a simple structure, so it may be appropriately applied to interior members of a vehicle having a complex shape.

The effects of the present disclosure are not limited to the above effects. It should be understood that the effects of the present disclosure may include all effects that may be inferred from the specification of the present disclosure.

The above-described description of specific exemplary embodiments of the present disclosure has been presented for the purpose of illustration and description, and is not intended to be exhaustive or to limit the disclosure to the precise form disclosed, and it is clear that various modifications and changes are all possible in accordance with the above teachings. The exemplary embodiments have been selected and described in order to interpret the specific principles of the present disclosure and its practical applications, so that other skilled in the art may utilize and implement various exemplary embodiments of the present disclosure and various alternative methods and modifications. The scope of the present disclosure is limited by the appended claims and their equivalent forms.

What is claimed is:

1. A mood lamp for a vehicle, comprising:
a bottom assembly including a housing, a light source, and a diffusion membrane; and
a top assembly including a core, a mesh, and a floodlight leather,
wherein the light source is located on one side of the housing close to the diffusion membrane, and an ink layer is applied to the core.

2. The mood lamp of claim 1, wherein:
the core is located on one side of the diffusion membrane far from the housing, the mesh is located on one side of the core far from the diffusion membrane, and the floodlight leather is located on one side of the mesh far from the core.

3. The mood lamp of claim 1, wherein:
the ink layer is applied to one side of the core far from the diffusion membrane and defines a pattern including a floodlight portion and a non-floodlight portion.

4. The mood lamp of claim 1, wherein:
the ink layer is applied to one side of the core close to the diffusion membrane and defines a pattern including a floodlight portion and a non-floodlight portion.

5. The mood lamp of claim 1, wherein:
the floodlight leather sequentially includes a surface treatment layer, a leather layer, an adhesive layer, and a fabric layer from one side far from the mesh to one side close to the mesh.

6. The mood lamp of claim 1, wherein:
a material of the housing is polycarbonate+acrylonitrile-butadiene-styrene, and a thickness of the housing is 2.5 to 3.0 mm.

7. The mood lamp of claim 1, wherein:
the light source includes two or more light-emitting diodes.

8. The mood lamp of claim 1, wherein:
a material of the diffusion membrane is polycarbonate, and a thickness of the diffusion membrane is 0.1 to 0.2 mm.

9. The mood lamp of claim 1, wherein:
a material of the core is polycarbonate, and a thickness of the core is 2.2 to 2.7 mm.

10. The mood lamp of claim 1, wherein:
a material of the ink layer is printing ink, and a thickness the ink layer is 0.065 to 0.075 mm.

11. The mood lamp of claim 1, wherein:
a material of the mesh is terylene and has a three-dimensional structure, and a thickness of the mesh is 3 to 10 mm.

12. The mood lamp of claim 5, wherein:
a material of the surface treatment layer is a heat-resistant resin, and a thickness of the surface treatment layer is 0.05 to 0.15 mm.

13. The mood lamp of claim 5, wherein:
a material of the leather layer is thermoplastic polyolefin, and a thickness of the leather layer is 0.2 to 0.7 mm.

14. The mood lamp of claim 5, wherein:
a material of the adhesive layer is high temperature melting polyurethane, and a thickness of the adhesive layer is 0.05 to 0.15 mm.

15. The mood lamp of claim 5, wherein:
a material of the fabric layer is polyethylene glycol terephthalate, and a thickness of the fabric layer is 0.5 to 1 mm.

16. The mood lamp of claim 1, wherein:
the light source is assembled to the housing through a screw, and the diffusion membrane is assembled to the housing through a buckle,
the core, the mesh, and the floodlight leather are assembled through an in-mold embossing molding process, and
the bottom assembly and the top assembly are assembled to each other through the screw.

17. The mood lamp of claim 1, further comprising:
a touch switch coupled to the mood lamp for the vehicle.

18. A manufacturing method of the mood lamp for a vehicle of claim 1, comprising:
assembling the light source and the diffusion membrane to the housing to manufacture a bottom assembly;
assembling the floodlight leather, the mesh, and the core through an in-mold embossing molding process to manufacture the top assembly; and
assembling the bottom assembly and the top assembly.

19. The manufacturing method of claim 18, wherein:
the in-mold embossing molding process includes:
vacuum molding the floodlight leather by heating the floodlight leather;
obtaining a core through injection molding;
spraying an ink layer to the core and bonding the mesh; and
press molding the floodlight leather, the mesh, and the core.

20. The manufacturing method of claim 19, wherein:
the floodlight leather is heated to a temperature of 170 to 180° C.
